(19) United States
(12) Patent Application Publication
(10) Pub. No.: US 2015/0016094 A1
(43) Pub. Date: Jan. 15, 2015

(54) HEAD-MOUNTED FRONT ILLUMINATION DEVICE

(71) Applicant: SNOW PEAK, INC., Sanjo-shi (JP)

(72) Inventors: Toru YAMAI, Sanjo-shi (JP); Ryoji HAYASHI, Sanjo-shi (JP)

(73) Assignee: SNOW PEAK, INC., Sanjo-shi (JP)

(21) Appl. No.: 14/166,139

(22) Filed: Jan. 28, 2014

(30) Foreign Application Priority Data
Jul. 10, 2013 (JP) 2013-144767

(51) Int. Cl. F21V 21/084

(52) U.S. Cl. CPC F21V 21/084
USPC 362/105

(57) ABSTRACT

To provide a highly exceptional, innovative head-mounted front illumination device in which when the head is slightly tilted as normal, the line of sight is directed further downward, and the area near the hands is looked at, the illumination range is automatically changed in correspondence with the downward eye movement and the area near the hands at the end of the line of sight is illuminated, and when the head is raised, the original forward direction is automatically illuminated again. A head-mounted front illumination device in which: a main body part (2) worn on the head is provided with an illumination part (1) for illuminating forward; an illumination range of the illumination part (1) is provided so as to be variable; and there is provided an automatic-illumination-range-change-enabling mechanism (3) in which when the head is tilted downwards and the face is turned downwards, the downwardly moved illumination range of the illumination part (1) is further modified, expanded, or moved downwards, and an area near the hands or an area near the feet is illuminated.

### TECHNICAL FIELD

The present invention relates to a head-mounted front illumination device such as a headlight which a climber, worker, rescue worker, night angler, or the like wears directly on the forehead using a headband or on the head by attaching to a helmet, hat, or spectacles to be worn on the head.

### BACKGROUND ART

Head-mounted front illumination devices for illuminating the activity range horizontally forward, downward and forward, or otherwise forward of the user during activity at nighttime or in otherwise dark conditions include those in which the illumination state, such as blinking or the light scattering state, in addition to the ON/OFF state, can be switched, those in which the brightness can be adjusted, and those in which the illumination direction (vertical angle) can be adjusted.

For example, a headlight which is worn by a climber or a night angler on the head using a headband and which illuminates horizontally forward, downward and forward, or otherwise forward can not only be provided with a switch for switching on/off the light source of the illumination part and have the headband displaced slightly to adjust the direction of illumination by the illumination part, but also have an illumination part (illumination unit) comprising a light source and a reflective light guide part for reflectively guiding the illumination light forwards provided so as to be capable of being adjusted by tilting, configured so that the optical axis of the illumination part can be adjusted vertically from the horizontal direction, and configured so that the area at the front to be illuminated and the distance at the front to be illuminated can be manually adjusted through tilting.

Meanwhile, in a headlight of such description, the illumination part is fixed so that the optical axis is oriented slightly downwards with respect to the horizontal so that the illumination range is located to the downward front, slightly ahead of the user (i.e., the road to the front). Therefore, if the user wishes to view a handheld map or design diagram or wishes to perform a task in the area near the hands, although the user will tilt the head downwards so that the face is facing downwards and forwards, the user will not excessively bend the neck and will instead only move the eyes and orient the line of sight further downwards to look at the area near the hands. Therefore, the area near the hands at the end of the line of sight will not be sufficiently illuminated.

In other words, when a person looks at the area near the hands as described above, the person will often only tilt the head to an extent at which the face is turned downwards and forwards instead of turning the head downwards to a sufficient extent, and will direct the line of sight downwards in such a state.

In particular, in the case of a head-mounted front illumination device provided to a helmet, the user is conscious of preventing the helmet from coming off or becoming displaced, and will therefore not tilt the head sufficiently for the face to be facing directly downwards. This tendency is also particularly pronounced in an instance in which the user must move the head frequently to, e.g., alternately look forwards and at the area near the hands.

Therefore, when looking at the area near the hands in a dark place, a person will often subconsciously tilt the head only by a slight degree, and direct only the eyes downwards while the face is facing downwards and forwards, instead of turning the head downwards as much as possible and turning the head directly downwards.

The same applies for an instance in which the user looks upwards; the illumination part is also manually moved in such an instance.

Therefore, when the user thus looks at the area near the hands, the user manually moves the illumination part unconsciously, naturally, or as a necessary action so that the illumination range (illumination direction) of the illumination part corresponds to the downward range within reach (i.e., so that the illumination is directed in the same direction as the line of sight).

Therefore, in a conventional headlight, every time the user wishes to look at the area near the hands, it is necessary to adjust the illumination part so as to be facing downwards and illuminating the area near the hands, and when the user brings the head back up and faces forwards, it is necessary to manually readjust the illumination part so as to be returned to the original substantially horizontal state and illuminate forward.

### DISCLOSURE OF THE INVENTION

### Problem to be Solved by the Invention

With the foregoing circumstances in view, an object of the present invention is to provide a highly exceptional, innovative head-mounted front illumination device in which: the conventional assumption that manual adjustment to turn the illumination part downwards when looking at the area near the hands is a necessary action is overcome; the aforementioned problem, which had not even been regarded as problematic, is resolved; and when the head is slightly tilted as normal, the line of sight is directed further downward, and the area near the hands is looked at as a person would have done conventionally, the illumination range is automatically changed in correspondence with the downward eye movement and the area near the hands at the end of the line of sight is illuminated, and when the head is raised, the original forward direction is automatically illuminated again.

### Means for Solving the Problem

An overview of the present invention will now be given with reference to the accompanying drawings.

The present invention is a head-mounted front illumination device that is worn on the head and illuminates forward, characterized in that: a main body part 2 worn on the head is provided with an illumination part 1 for illuminating forward; an illumination range of the illumination part 1 is provided so as to be variable; and there is provided an automatic-illumination-range-change-enabling mechanism 3 in which when the head is tilted downwards and the face is turned downwards causing the main body part 2 worn on the head to tilt downwards and the illumination part 1 to also tilt downwards, the illumination range, which has moved downwards, of the illumination part 1 is further expanded, modified, or moved downwards automatically, and an area near the hands or an area near the feet, which is even nearer the user than the downward and forward direction in which the face is facing, is illuminated.

A second aspect of the present invention relates to the head-mounted front illumination device according to the first aspect, characterized in that the degree to which, without the face being turned directly downwards, the illumination range of the illumination part 1 is changed by the automatic-illumination-range-change-enabling mechanism 3 is set so that when the user tilts their neck and turns the face downwards and forwards in order to view, from above, a handheld object in front of the stomach or the chest, the illumination range of the illumination part 1 is automatically expanded, modified, or moved further downwards than the direction in which the face is facing, and the handheld object at the end of the line of sight is illuminated.

A third aspect of the present invention relates to the head-mounted front illumination device according to the second aspect, characterized in that the degree by which the illumination range of the illumination part 1 changes is greater in an instance in which the illumination part 1 is appreciably tilted downwards than in an instance in which the illumination part 1 is tilted slightly downwards, without there being a proportional relationship with the amount by which the illumination part 1 is caused to tilt by the tilting movement of the main body part 2.

A fourth aspect of the present invention relates to the head-mounted front illumination device according to the first aspect, characterized in that the illumination part 1 is provided so as to be capable of tilting vertically, the illumination range of the illumination part 1 is provided so as to be variable, and the automatic-illumination-range-change-enabling mechanism 3 is configured from an automatic overtilting mechanism 4, in which when the head is tilted downwards and the face is turned downwards causing the main body part 2 worn on the head to tilt downwards and the illumination part 1 also to tilt downwards, the automatic overtilting mechanism 4 tilts the illumination part 1 further downwards and automatically tilts the illumination part 1 so that an area near the hands or an area near the feet, which is even nearer the user than the downward and forward direction in which the face is facing, is illuminated.

A fifth aspect of the present invention relates to the head-mounted front illumination device according to the first aspect, characterized in that: a plurality of the illumination parts 1 or a plurality of light sources 5 of the illumination part 1 are provided; the ON/OFF state or the luminosity of each of the light sources 5 is controlled, whereby the illumination range of the illumination part 1 is provided so as to be variable; and the automatic-illumination-range-change-enabling mechanism 3 is configured from an automatic lighting control mechanism 6 in which when the head is tilted downwards and the face is turned downwards causing the main body part 2 worn on the head to tilt downwards and the illumination part 1 also to tilt downwards, a light source 5 on the lower side of the light sources 5 of the illumination part 1 is activated or the luminosity thereof is increased, the illumination range of the downwardly tilted illumination part 1 is expanded or modified downwards, and an area near the hands or an area near the feet, which is even nearer the user than the downward and forward direction in which the face is facing, is illuminated.

A sixth aspect of the present invention relates to the head-mounted front illumination device according to the first aspect, characterized in that the light scattering state or the reflective light guiding state of the illumination part 1 is provided so as to be variable; the illumination range of the illumination part 1 is provided so as to be variable; and the automatic-illumination-range-change-enabling mechanism 3 is configured from an automatic-illumination-state-change-enabling mechanism 7 in which when the head is tilted downwards and the face is turned downwards causing the main body part 2 worn on the head to tilt downwards and the illumination part 1 also to tilt downwards, the light scattering state or the reflective light guide state of the illumination part is varied and the illumination range is further expanded or modified downwards, and an area near the hands or an area near the feet, which is even nearer the user than the downward and forward direction in which the face is facing, is illuminated.

A seventh aspect of the present invention relates to the head-mounted front illumination device according to the fourth aspect, characterized in that the automatic overtilting mechanism 4 comprises a tilt prevention/allowance switching mechanism 8 for: preventing the illumination part 1, which is provided so as to be capable of tilting vertically, from tilting downwards, and directing the illumination forward, before the main body part 2 tilts downwards; and allowing the illumination part 1 to tilt downwards when the main body part 2 tilts downwards and the illumination part 1 also tilts; and a suspension tilt mechanism 9 in which the main body part 1 tilting downwards causes the tilt prevention/allowance switching mechanism 8 to switch to a tilt allowance state and causes the illumination part 1 to automatically tilt, under gravity, downwards by a predetermined amount or otherwise in correspondence with the incline of the main body part 2.

### Effect of Invention

The present invention is configured as described above, and therefore provides a highly exceptional, innovative head-mounted front illumination device in which when the head is slightly tilted as normal, the line of sight is directed further downward, and the area near the hands is looked at as a person would have done conventionally, the illumination range is automatically changed in correspondence with the downward eye movement and the area near the hands at the end of the line of sight is illuminated, and when the head is raised, the original forward direction is automatically illuminated again.

In the invention according to the second and third aspects, an automatic switch is made between the state in which the front is illuminated and activity is performed at nighttime or in otherwise dark conditions and the state in which the area near the hands is illuminated and a handheld object or document such as a map or a design diagram is viewed, improving the ease of use and convenience. In particular, the invention disclosed in claim 3 results in an extremely practical head-mounted front illumination device in which: when the user is looking forward and the front direction is being illuminated, even when the head tilts slightly, the degree of corresponding change in the illumination range of the illumination part is reduced (moderated), preventing the illumination range from changing by an unnecessary extent; and when the head is tilted appreciably such as when the area near the hands is viewed, the illumination range changes downwards to a sufficient extent so that the area near the hands can be reliably illuminated.

The invention according to the fourth and seventh aspects is configured so that the illumination part is automatically tilted and the illumination range is moved downwards in correspondence with a development of an incline, therefore resulting in an extremely practical head-mounted front illumination device capable of readily realizing the present invention. In particular, in the invention according to the seventh aspect, the automatic tilting is made further pronounced by gravity and the illumination range is moved downwards in correspondence with the tilt of the illumination part, therefore resulting in an even more practical, innovative head-mounted front illumination device.

The invention according to the fifth aspect is configured so that the tilt state is sensed using, e.g., an incline sensor, and the ON/OFF states or the luminosity of a plurality of light sources are thereby controlled to change the illumination range, resulting in an extremely practical head-mounted front illumination device capable of readily realizing the present invention.

The invention according to the sixth aspect is configured so that the tilt state is sensed using, e.g., an incline sensor, and the light scattering state or the reflective light guiding state is changed to change the illumination range, resulting in an extremely practical head-mounted front illumination device capable of readily realizing the present invention.

### BRIEF DESCRIPTION OF THE DRAWINGS

FIG. 1 is a perspective view of the present example;

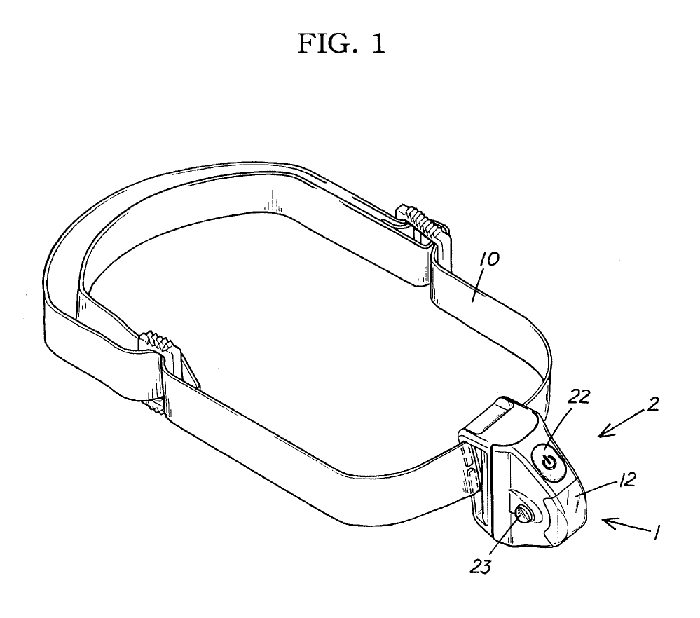

FIG. 2 illustrates the present example during forward illumination;

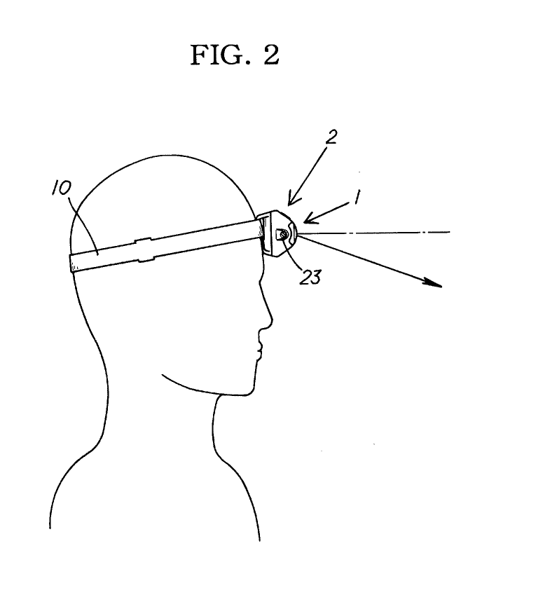

FIG. 3 illustrates the present example during illumination of the area by the hands (i.e., when the head is tilted downwards, the face is turned downwards and forwards, and the area by the hands in the direction of the line of sight is illuminated);

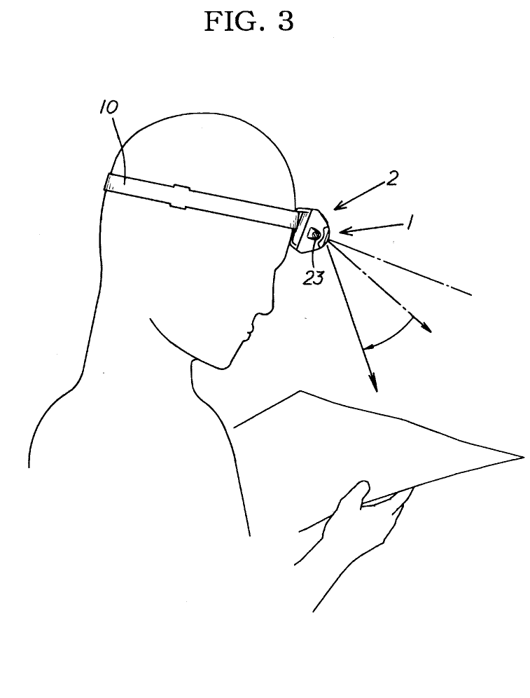

FIG. 4 illustrates the present example during upward illumination (i.e., when the head is tilted upwards, the face is turned upwards, and the direction of the line of sight, which is further upwards, is illuminated);

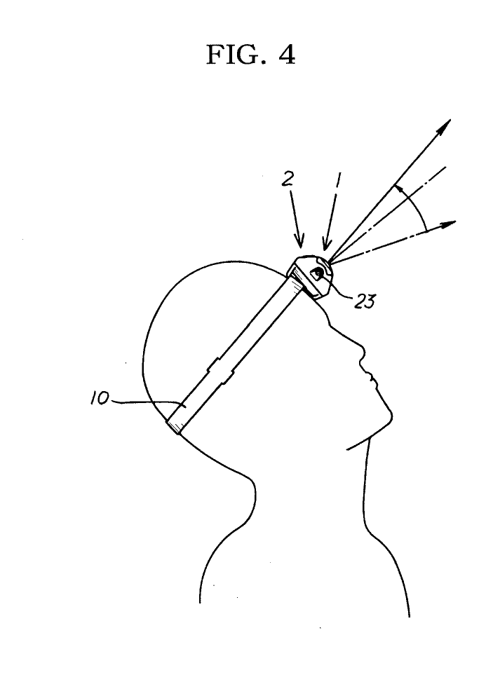

FIG. 5 is a schematic perspective view of the principal part of the automatic-illumination-range-change-enabling mechanism (automatic overtilting mechanism) of the present example (example 1) during forward illumination;

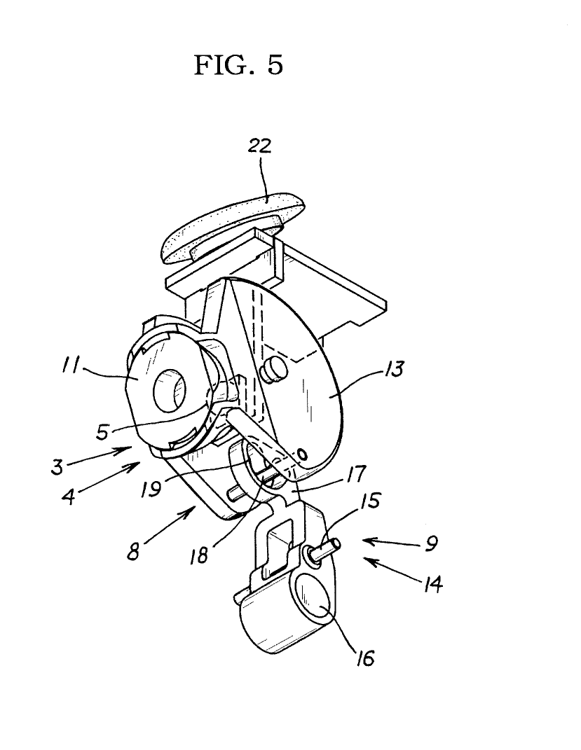

FIG. 6 is a schematic side cross-section view of the principal part of the automatic-illumination-range-change-enabling mechanism (automatic overtilting mechanism) of the present example (example 1) during forward illumination;

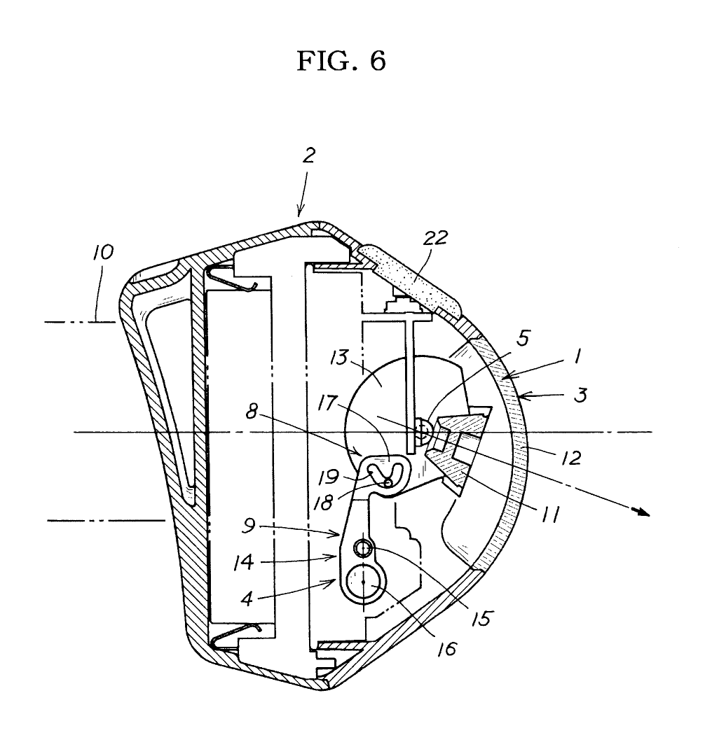

FIG. 7 is a schematic perspective view of the principal part of the automatic-illumination-range-change-enabling mechanism (automatic overtilting mechanism) of the present example (example 1) during illumination of the area by the hands;

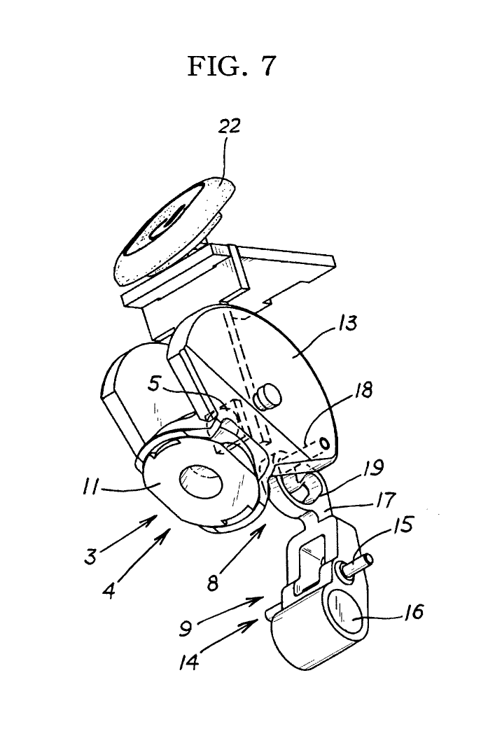

FIG. 8 is a schematic side cross-section view of the principal part of the automatic-illumination-range-change-enabling mechanism (automatic overtilting mechanism) of the present example (example 1) during illumination of the area by the hands;

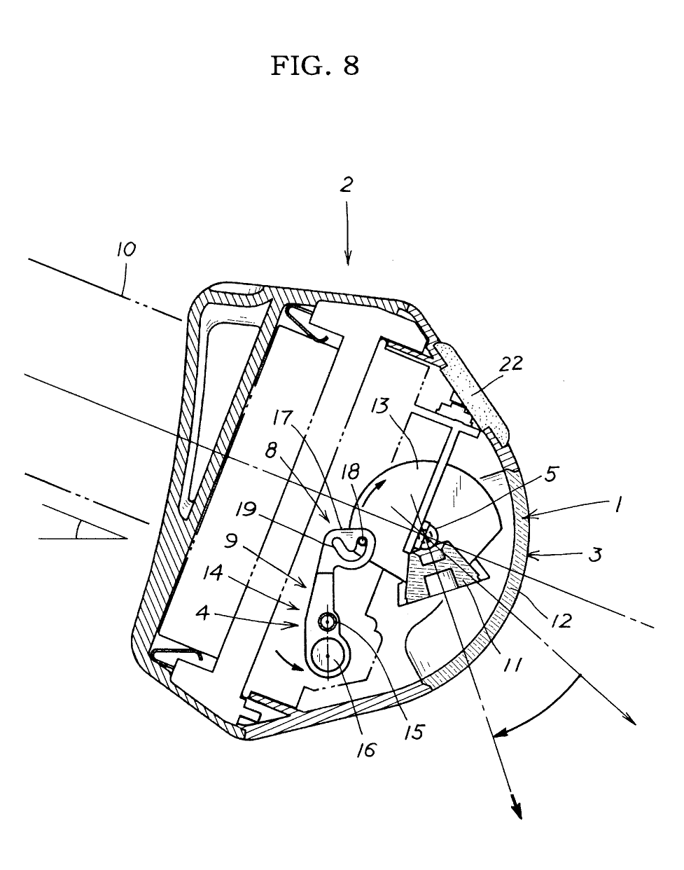

FIG. 9 illustrates the operation of the principal part of the automatic-illumination-range-change-enabling mechanism (automatic overtilting mechanism) of the present example (example 1) during illumination of the area by the hands;

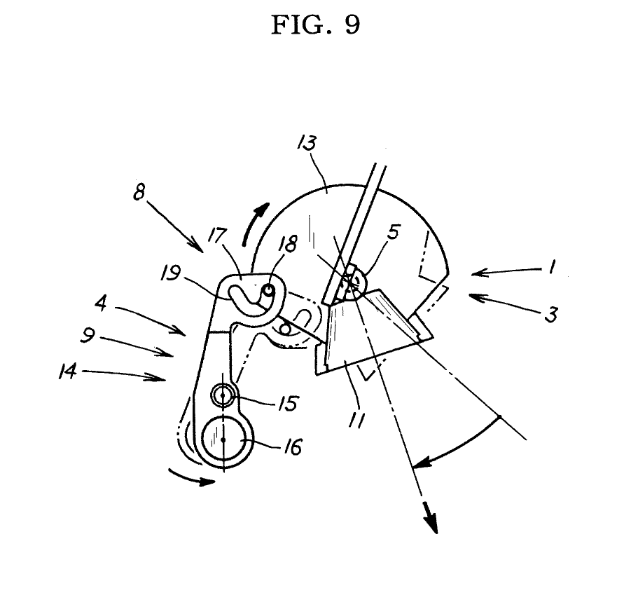

FIG. 10 is a schematic perspective view of the principal part of the automatic-illumination-range-change-enabling mechanism (automatic overtilting mechanism) of the present example (example 1) during upward illumination;

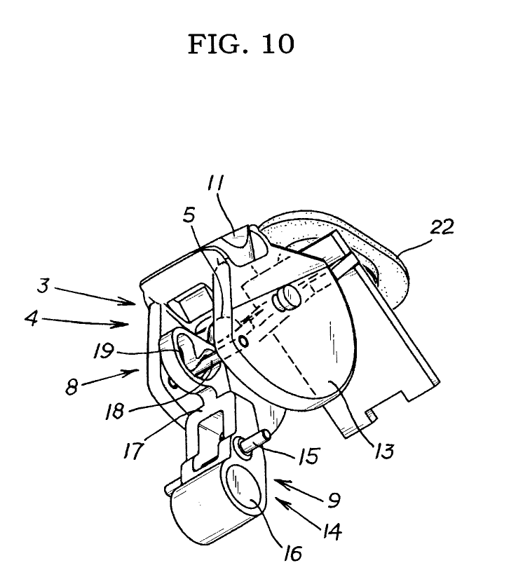

FIG. 11 is a schematic side cross-section view of the principal part of the automatic-illumination-range-change-enabling mechanism (automatic overtilting mechanism) of the present example (example 1) during upward illumination;

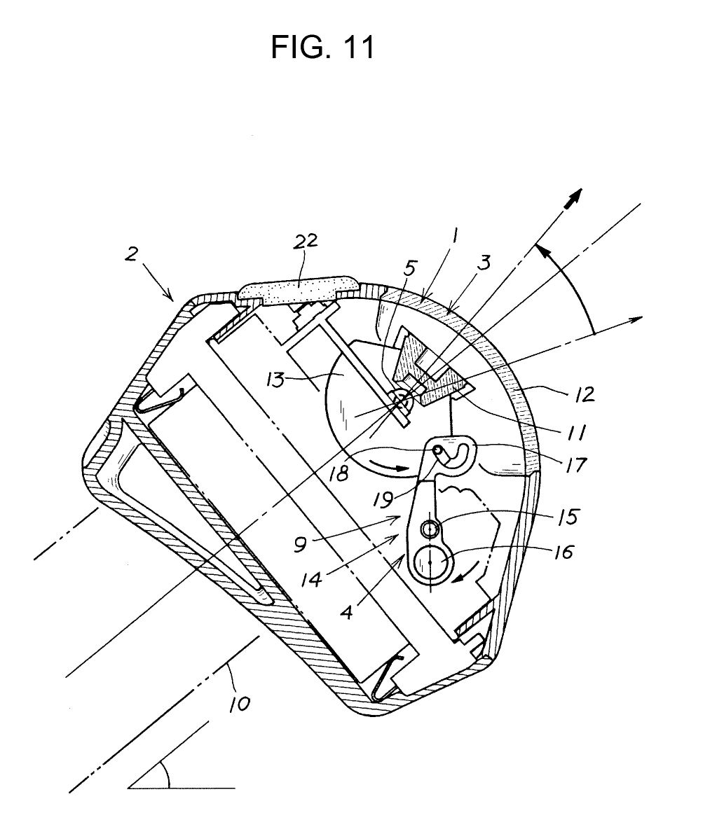

FIG. 12 illustrates the operation of the principal part of the automatic-illumination-range-change-enabling mechanism (automatic overtilting mechanism) of the present example (example 1) during upward illumination;

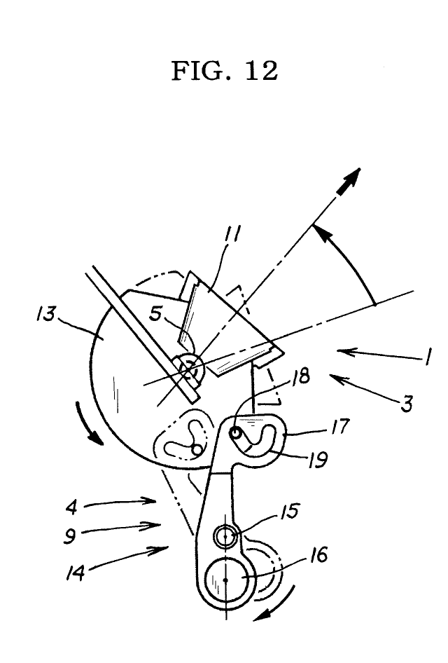

FIG. 13 is a schematic side cross-section view of the principal part of the automatic-illumination-range-change-enabling mechanism (automatic overtilting mechanism) of the present example (example 2) during illumination of the area by the hands;

FIG. 14 is a schematic side cross-section view of the principal part of the automatic-illumination-range-change-enabling mechanism (automatic overtilting mechanism) of the present example (example 3) during illumination of the area by the hands; and

FIG. 15 is a schematic side cross-section view of the principal part of the automatic-illumination-range-change-enabling mechanism (automatic overtilting mechanism) of the present example (example 4) during illumination of the area by the hands.

### BEST MODE FOR CARRYING OUT THE INVENTION

A preferred embodiment of the present invention will now be briefly described through indicating the action of the present invention with reference to the accompanying drawings.

When a person looks at the area near the hands; e.g., looks at a handheld object in front of the stomach or the chest from above, from a state in which the front direction is being illuminated, e.g., a state in which the optical axis of the illumination part 1 is directed horizontally forward or slightly downward with respect to the horizontal (i.e., downwards and forwards) and the front direction is being illuminated, a person will bend the beck slightly, tilt the head downwards, and turn the face downwards and forwards, but will often move the eyes further downwards, direct the line of sight at the area near the hands, and view the object area near the hands while maintaining the state in which the neck is slightly tilted (i.e., a state in which the face is turned downwards and forwards), instead of turning the face nearly directly downwards.

The present invention comprises an automatic-illumination-range-change-enabling mechanism 3 for illuminating the area near the hands or by the feet at the end of the line of sight in correspondence with the tilting of the head.

Specifically, when an object in the area near the hands is viewed as described above, the illumination range of the head-mounted front illumination device automatically changes in correspondence with the action of the person, and the illumination range is expanded, modified, or moved downwards so as to illuminate the area near the hands, which is located in the direction of the line of sight further downwards from the direction in which the face is facing.

In other words, while the illumination range of the illumination part 1 for illuminating horizontally forwards, downwards and forwards, or otherwise forward tilts downwards with the tilting movement of the head and causes the downward and forward direction to be illuminated, the automatic-illumination-range-change-enabling mechanism 3 operates with the tilting movement of the head and the illumination range is automatically changed further downwards (i.e., expanded, changed, or moved downwards) than the illumination range described above, and the area near the hands located at the end of the line of sight in a state in which the head is slightly tilted as normal is illuminated.

For example, with the tilting movement of the head, the illumination part 1 is automatically tilted under gravity; the tilting movement of the head is sensed and the illumination part 1 is driven so as to tilt; or a plurality of light sources 5 are provided and the ON/OFF states of the light sources 5 are switched, the luminosity is changed, or the light scattering state or the reflective light guiding state is changed, whereby the illumination range is expanded, modified, or moved downwards, causing the object to be viewed in the area near the hands in the direction of the line of sight when the head is tilted to be automatically illuminated in a reliable manner without further tilting the head.

Thus, in the present invention, when the head is tilted in order to view an object in the area near the hands, the illumination range of the illumination part 1 automatically changes with the tilting movement of the head so as to illuminate the object in the area near the hands in the direction of the line of sight directed further downwards.

Accordingly, there is obtained a highly exceptional head-mounted front illumination device that obviates the need for a manual adjustment operation performed on the illumination part 1, which has been conventionally thought of as a necessary action, and in which when the head is tilted, the illumination range is automatically changed and the area near the hands is illuminated without performing a manual adjustment as in the past or without the need to move the neck excessively in order to direct the illumination as normally required.

### Example 1

A specific example 1 of the present invention will now be described with reference to the accompanying drawings.

The present example is configured so that: a main body part 2 disposed on the forehead is provided with an illumination part 1 for illuminating forward; an illumination range of the illumination part 1 is provided so as to be variable; and there is provided an automatic-illumination-range-change-enabling mechanism 3 in which when the head is tilted downwards and the face is turned downwards, causing the main body part 2 worn on the head to tilt downwards and the illumination part 1 to also tilt downwards, the illumination range, which has moved downwards with the tilting movement of the head, of the illumination part 1 is further expanded, modified, or moved downwards automatically, and an area near the hands or an area near the feet, which is even nearer the user than the downward and forward direction in which the face is facing, is illuminated.

Specifically, the illumination part 1 comprises a light source 5, a reflective light guide part 11 for reflectively guiding the illumination light from the light source 5 and imparting directivity, a light transmission part 12 for transmitting and scattering the illumination light or further widening or narrowing the illumination angle, and other elements. The illumination part 1 is configured so that actuating, switching, or changing such elements causes the illumination range of the illumination part 1 to change, with the tilting movement of the head, further downwards than the tilting movement.

For example, the automatic-illumination-range-change-enabling mechanism 3 is configured so that when the user tilts the neck and turns the face downwards and forwards in order to view, from above, a handheld object in front of the stomach or the chest, the illumination range of the illumination part 1 is automatically changed, i.e., expanded, modified, or moved, further downwards than the direction in which the face is facing, and the handheld object at the end of the line of sight is illuminated, without turning the face directly downwards.

Specifically, the degree by which the automatic-illumination-range-change-enabling mechanism 3 changes the illumination range of the illumination part 1 is set so that the area near the hands in the direction of the line of sight is illuminated as described above.

In addition, in the present example, the degree by which the illumination range of the illumination part 1 changes is greater in an instance in which the illumination part 1 is appreciably tilted downwards than in an instance in which the illumination part 1 is tilted slightly downwards, without there being a proportional relationship with the amount by which the illumination part 1 is caused to tilt with the head by the tilting movement of the main body part 2.

Specifically, when the user is looking forwards (i.e., the face is facing horizontally forwards) and the horizontally forward or downward and forward direction is being illuminated, even if the head is tilted slightly, the degree of corresponding change in the illumination range of the illumination part 1 is reduced (including to zero), whereby the illumination range is prevented from changing unnecessarily; and the degree of change of the illumination range is set so that a change occurs when the tilt reaches or exceeds a given tilt angle or the illumination range changes appreciably in one action when the head is tilted appreciably such as when the area near the hands is viewed.

In addition, the present example is configured so that when the user looks upwards instead of downwards, when the head is tilted upwards, the illumination range similarly automatically changes so as to move further upwards to illuminate further upwards than the upward direction in which the face is turned, i.e., so as to illuminate the direction of the line of sight, since when the user looks upwards, as with when the user views the area near the hands, the eyes are moved beyond the direction in which the face is turned, and the line of sight is directed upwards.

A first example (example 1) will now be described more specifically.

In the present example, the illumination part 1 is provided so as to be capable of tilting vertically, the illumination range of the illumination part 1 is provided so as to be variable, and the automatic-illumination-range-change-enabling mechanism 3 is configured from an automatic overtilting mechanism 4, in which when the head is tilted downwards and the face is turned downwards causing the main body part 2 worn on the head to tilt downwards and the illumination part 1 also to tilt downwards, the automatic overtilting mechanism 4 automatically tilts the illumination part 1 further downwards so that an area near the hands or an area near the feet, which is even nearer the user than the downward and forward direction in which the face is facing, is illuminated.

Specifically, the present example is configured so that without using a tilt sensor or the like, the illumination part 1 is provided so as to be capable of tilting, and when the head is tilted to cause the main body part 2 and the illumination part 1 to tilt, the illumination range moves downwards due to the tilting movement of the head, and the automatic overtilting mechanism 4 causes the illumination part 1 to automatically further tilt, under gravity, in the same tilting direction and the illumination range moves further downwards.

Even more specifically, in the present example, a headband 10 provided to the main body part 2 is placed around the head and the main body part 2 is worn on the front of the forehead, and the illumination part 1 and a power supply are internally provided in the main body part 2 and the illumination part 1 illuminates forward with respect to the head.

In the present example, the illumination part 1 is configured so that the light source 5 (LED), which is illuminated by the power supply and switched on and off by a light switch 22 located above, is provided on the inside of the light transmission part 12 (lens cover), the reflective light guide part 11 (acrylic lens) for reflectively guiding the illumination light from the light source 5 and imparting directivity is provided between the light source 5 and the light transmission part 12, and the illumination light imparted with directivity by the light transmission part 12 is beamed forward, e.g., downward and forward so that the optical axis is oriented 20° downwards with respect to the horizontal direction when the head-mounted front illumination device is worn on the forehead, and the illumination part 1 illuminates forward.

In the present example, although the illumination part 1 may be provided so that each of the units can be moved and adjusted, the reflective light guide part 11 of the illumination part 1 is provided so as to be capable of rotationally tilting vertically with respect to the light source 5, and the illumination part 1 is provided so as to be capable of tilting vertically.

Specifically, the reflective light guide part 11 is provided so as to be capable of rotationally tilting vertically with respect to the light source 5, which is fixed in the main body part 2, and the illumination part 1 is configured so as to be capable of tilting. In other words, the optical axis of illumination light from the light source 5 changes and the illumination range changes according to the degree by which the reflective light guide part 11 is tilted, and the illumination range of the illumination part 1 can be varied in the vertically direction.

In more detail, in the present example, the automatic overtilting mechanism 4 comprises: a tilt prevention/allowance switching mechanism 8 for: preventing the illumination part 1, which is provided so as to be capable of tilting vertically, from tilting downwards, and directing the illumination forward, before the main body part 2 tilts downwards, and allowing the illumination part 1 to tilt downwards when the main body part 2 tilts downwards and the illumination part 1 also tilts; and a suspension tilt mechanism 9 in which the main body part 2 tilting downwards causes the tilt prevention/allowance switching mechanism 8 to switch to a tilt allowance state and causes the illumination part 1 to automatically tilt, under gravity, downwards by a predetermined amount or otherwise in correspondence with the incline of the main body part 2.

Specifically, in the present example, as described above, the reflective light guide part 11 is provided so as to be capable of rotationally tilting downwards and the illumination part 1 is provided so as to be capable of tilting vertically, and the illumination range of the illumination part 1 is provided so as to be variable.

However, when the main body part 2 on the forehead is worn so as to face the direction that the face is facing, and the face is facing horizontally forwards, the reflective light guide part 11 is held at an orientation facing 20° downwards with respect to the horizontal direction, and is set so as to remain immobile when the head is slightly tilted, and move only by a small amount (i.e., moderately) when the head moves slightly further.

The present example is configured so that the reflective light guide part 11, which is positioned in front of the light source 5 and which determines the direction of the optical axis, is provided to a rotation part 13, which rotates about the position of the light source 5. The rotation part 13 rotates by a predetermined angle, whereby the position of the reflective light guide part 11 relative to the light source 5 rotationally moves, and the direction of the illumination light from the light source 5 (i.e., the illumination range) changes vertically.

Specifically, the reflective light guide part 11 barely rotationally tilts when the head is facing horizontally forward or is then tilted slightly, but when the head is tilted appreciably to view the area near the hands, the tilt prevention/allowance switching mechanism 8 assumes a tilt allowance state, and the suspension tilt mechanism 9 additionally causes the rotation part to rotate, whereby the reflective light guide part 11 rotationally tilts automatically.

The rotation part 13 is configured so that a tilting movement of the head causes the suspension tilt mechanism 9 to generate a rotating force. More specifically, the rotation part 13 is configured so that a weight rotation part 14 (weight holder), which tilts and thereby causes the rotation part 13 to automatically rotate under gravity, is suspended from the rotation part 13 provided with the reflective light guide part 11 for causing the direction of illumination of the illumination part 1 to change in the vertical direction.

This weight rotation part 14 is provided so as to be capable of rotating about a rotation shaft 15. A weight part 16, which moves in the perpendicular direction with the downward tilt of the rotation shaft 15, is provided. A linking part 17, which links to the rotation part 13, is provided above the weight part 16. When the main body part 2 is tilted by the neck being bent and the head being tilted, the weight part 16 moves under gravity in the perpendicular direction, whereby the weight rotation part 14 (the linking part 17 at the upper part of the weight rotation part 14) rotates so as to be pivoted about the rotation shaft 15. In other words, the linking part 17 at the upper part of the weight rotation part 14 rotates with the weight-balance-induced rotation of the weight part 16 at the lower part of the weight rotation part 14, and the rotation part 13, which is linked to the linking part 17, is caused to rotate.

The link between the rotation part 13 and the linking part 17 of the weight rotation part 14 is configured so that the link is made by an engagement between a pin 18 and a cam groove 19 (long hole). The rotation of the linking part 17 causes the rotation part 13 to rotate smoothly, the reflective light guide part 11 provided to the rotation part 13 rotationally tilts by a predetermined angle on front of the light source 5, and the illumination range automatically moves downwards.

More specifically, the linking part 17 at the upper part of the rotation shaft 15 of the weight rotation part 14 and the rotation periphery part of the rotation part 13 are linked by an engagement between the pin 18 and the cam groove 19. For example, the shape of the cam groove 19 of the linking part 17, with which the pin 18 provided to the rotation periphery part of the rotation part 13 engages, is set so that when the head is tilted and the weight part 16 rotates under gravity so as to move to a position directly below the pivot position, a cam force is generated by the cam groove 19 provided to the linking part 17 and the rotation part 13 rotates smoothly via the pin 18, and the reflective light guide part 11 rotates by a predetermined angle with respect to the illumination part 1, i.e., the light source 5.

Thus, the rotation part 13 provided with the reflective light guide part 11 of the illumination part 1 and the weight rotation part 14 which rotates according to the degree of tilt are linked by the pin 18 and the cam groove 19 to constitute the tilt prevention/allowance switching mechanism 8 and the suspension tilt mechanism 9.

The shape of the cam groove 19 is set so that as described above, when the head is facing forward, the illumination part 1 (reflective light guide part 11) is positioned so as to face a predetermined downward and forward direction, and when the head then tilts slightly, even though the weight rotation part 14 rotates, the rotation part 13 barely rotates or only rotates slightly. When the illumination part 1 tilts by or over a predetermined amount and the weight rotation part 14 rotates appreciably due to the setting made regarding the degree to which the cam groove 19 is imparted with an arcuate shape, the shape of the cam groove 19 causes the rotation part 13 to rotate appreciably, and the reflective light guide part 11 is caused to rotationally tilt downwards by an appreciable amount. In other words, in the present example, the shape of the cam groove 19 guides the rotational tilting of the reflective light guide part 11 and determines the degree of change in the amount of rotational tilting.

In other words, the present example is configured, e.g., by setting the shape of the cam groove 19, so that the amount of tilt of the head and the amount of tilt of the illumination part 1 (reflective light guide part 11 in the present example) are not proportional to each other, and the illumination part 1 does not swing downwards if the head is only tilted slightly but tilts downwards by an appreciable amount (e.g., 30°) in line with the purpose (i.e., so as to illuminate the area near the hands) if the head is tilted appreciably in order to, e.g., view the area near the hands. In other words, the shape of the cam groove 19 or another parameter is set so that the illumination part 1 does not tilt unnecessarily, and the illumination range automatically moves downwards by a sufficient extent so that the area near the hands is illuminated when the area near the hands is viewed.

The shape of the cam groove 19 is set so as to be symmetrical about the portion at the center when the user is looking forward, and when the user looks upwards as described further above, the rotation part 13 is caused to rotate further in the corresponding direction (i.e., upward) than the direction in which the face is facing, the reflective light guide part 11 is caused to tilt, and the illumination range is automatically moved in the corresponding direction.

In the present example, the automatic overtilting mechanism 4 (automatic-illumination-range-change-enabling mechanism 3) is configured so that, e.g., when the head is tilted by approximately 20° in relation to the illumination part 1 (reflective light guide part 11) initially facing 20° downwards and forwards, the illumination part 1 (reflective light guide part 11) further tilts 30° downwards and the illumination range moves downwards. However, the present example is configured so as to be switchable between preventing the mechanism from operating or preventing the mechanism from returning to the original state after operating, e.g., by providing an illumination angle fixing knob 23 (e.g., a screw knob for preventing the rotation part 13 from rotating), for switching to and from operation stoppage, for fixing or releasing the rotation part 13 provided with the reflective light guide part 11, in order to prevent the mechanism from operating.

### Second Example

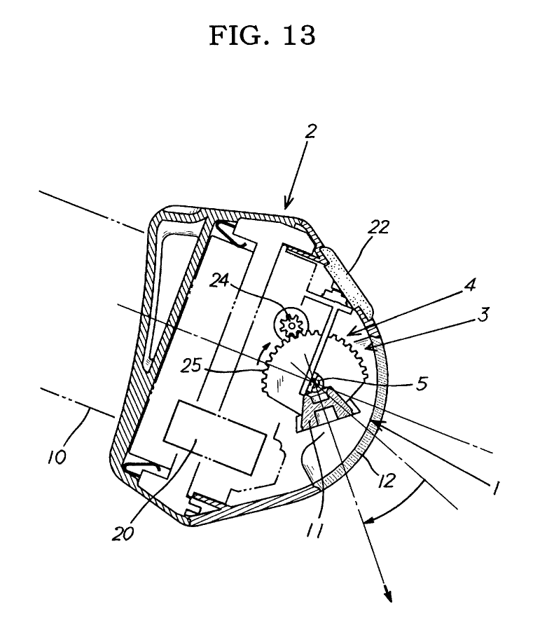

FIG. 13 shows a second example (example 2).

In this example, the automatic overtilting mechanism 4 does not comprise the tilt prevention/allowance switching mechanism 8 and the suspension tilt mechanism 9. A tilt sensor 20 senses that the head (main body part 2) has tilted by or over a predetermined angle, and in response, or if the head has tilted by or over a predetermined angle, the rotation part 13, which is provided with the reflective light guide part 11 of the illumination part 1 configured, e.g., in a similar manner to that in the first example, is caused to rotate by a predetermined amount using a motorized force from an electric motor or the like instead of under gravity, and the illumination part 1 (e.g., the reflective light guide part 1) is driven so as to automatically tilt.

Specifically, e.g., a pinion 24, which is caused by the electric motor to rotate, is caused to engage with teeth 25 on the periphery of the rotation part 13, and the resulting gear mechanism causes the rotation part 13 to rotate by a predetermined amount. There is provided a motor control unit for controlling the electric motor according to the degree of tilt sensed by the tilt sensor 20.

### Third Example

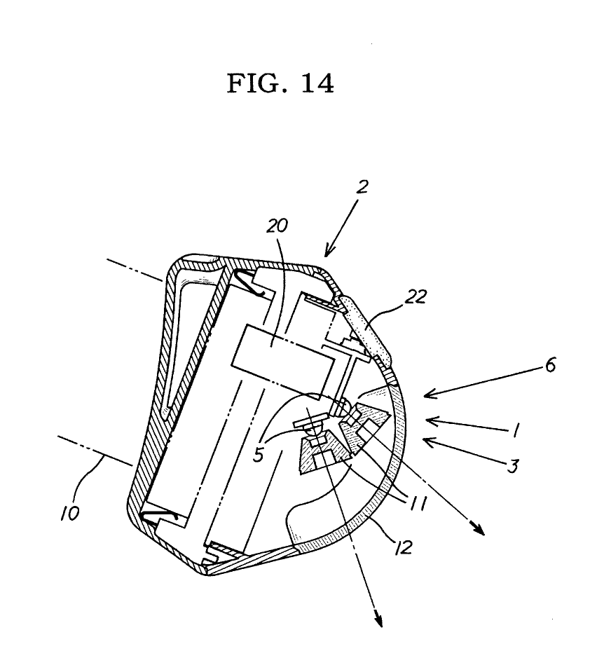

FIG. 14 shows a third example (example 3). In this example: a plurality of the illumination parts 1 or a plurality of light sources 5 of the illumination part 1 are provided; the ON/OFF state or the luminosity of each of the light sources 5 is controlled, whereby the illumination range of the illumination part 1 is provided so as to be variable; and the automatic-illumination-range-change-enabling mechanism 3 is configured from an automatic lighting control mechanism 6 in which when the head is tilted downwards and the face is turned downwards causing the main body part 2 worn on the head to tilt downwards and the illumination part 1 also to tilt downwards, a light source 5 on the lower side of the light sources 5 of the illumination part 1 is activated or the luminosity thereof is increased, the illumination range of the downwardly tilted illumination part 1 is expanded or modified downwards, and an area near the hands or an area near the feet, which is even nearer the user than the downward and forward direction in which the face is facing, is illuminated.

In other words, in the present example, a plurality of illumination parts 1, each of which comprising a light source 5 and a reflective light guide part 11, are provided in the vertical direction. The illumination part 1 on the upper side is configured by the reflective light guide part 11 to illuminate downwards and forwards. The illumination part 1 on the lower side is configured by the reflective light guide part 11 to direct, when the head is tilted, the optical axis further downwards so that the area near the hands is illuminated. The present example is provided with a lighting control unit for automatically activating the light source 5 of the lower illumination part 1 and expanding the illumination range downwards, or extinguishing the light source 5 of the upper illumination part 1 and modifying the illumination range downwards, when, as in the second example, the tilt sensor 20 senses that the tilt has reached or exceeded a predetermined angle.

### Fourth Example

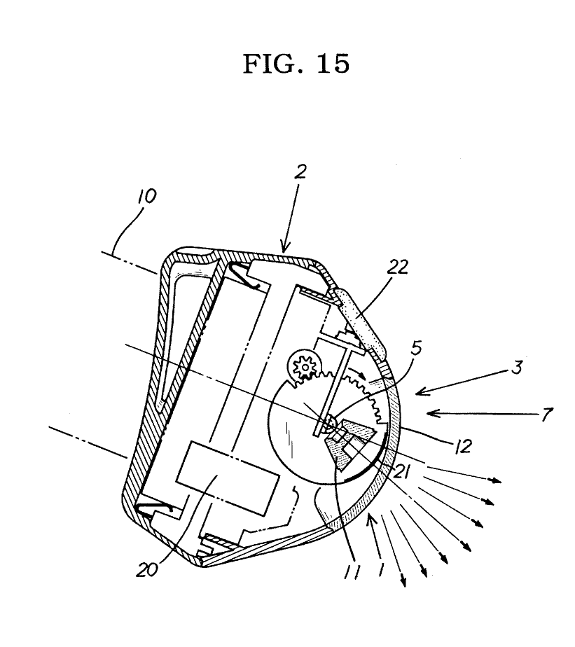

FIG. 15 shows a fourth example (example 4). In the present example, the light scattering state or the reflective light guiding state of the illumination part 1 is provided so as to be variable; the illumination range of the illumination part 1 is provided so as to be variable; and the automatic-illumination-range-change-enabling mechanism 3 is configured from an automatic-illumination-state-change-enabling mechanism 7 in which when the head is tilted downwards and the face is turned downwards causing the main body part 2 worn on the head to tilt downwards and the illumination part also to tilt downwards, the light scattering state or the reflective light guide state of the illumination part 1 is varied and the illumination range is further expanded or modified downwards, and an area near the hands or an area near the feet, which is even nearer the user than the downward and forward direction in which the face is facing, is illuminated.

Specifically, as with the second and third examples, a tilt sensor 20 is provided, and when the head tilts by or over a predetermined angle, a light scattering plate 21 (light diffusion sheet) for modifying the light scattering state using a motorized force such as that from an electric motor is actuated so as to be positioned in front of the reflective light guide part 11 of the illumination part 1 and caused to scatter the illumination light to expand the illumination range. If the head is tilted so as to view the area near the hands, the light scattering plate 21 is interposed as described above, whereby the illumination range automatically expands downwards and the area near the hands is illuminated.

The present invention is not limited to examples 1-4, and the specific configuration of each of the constituent elements can be designed as appropriate.

1. A head-mounted front illumination device that is worn on the head and illuminates forward, characterized in that:
a main body part worn on the head is provided with an illumination part for illuminating forward;
an illumination range of the illumination part is provided so as to be variable; and
there is provided an automatic-illumination-range-change-enabling mechanism in which when the head is tilted downwards and the face is turned downwards, causing the main body part worn on the head to tilt downwards and the illumination part to also tilt downwards, the downwardly moved illumination range of the illumination part is further expanded, modified, or moved downwards automatically, and an area near the hands or an area near the feet, which is even nearer the user than the downward and forward direction in which the face is facing, is illuminated.

2. The head-mounted front illumination device according to claim 1, characterized in that the degree to which, without the face being turned directly downwards, the illumination range of the illumination part is changed by the automatic-illumination-range-change-enabling mechanism is set so that when the user tilts their neck and turns the face downwards and forwards in order to view, from above, a handheld object in front of the stomach or the chest, the illumination range of the illumination part is automatically expanded, modified, or moved further downwards than the direction in which the face is facing, and the handheld object at the end of the line of sight is illuminated.

3. The head-mounted front illumination device according to claim 2, characterized in that the degree by which the illumination range of the illumination part changes is greater in an instance in which the illumination part is appreciably tilted downwards than in an instance in which the illumination part is tilted slightly downwards, without there being a proportional relationship with the amount by which the illumination part is caused to tilt by the tilting movement of the main body part.

4. The head-mounted front illumination device according to claim 1, characterized in that the illumination part is provided so as to be capable of tilting vertically, the illumination range of the illumination part is provided so as to be variable, and the automatic-illumination-range-change-enabling mechanism is configured from an automatic overtilting mechanism, in which when the head is tilted downwards and the face is turned downwards causing the main body part worn on the head to tilt downwards and the illumination part also to tilt downwards, the automatic overtilting mechanism tilts the illumination part further downwards and automatically tilts the illumination part so that an area near the hands or an area near the feet, which is even nearer the user than the downward and forward direction in which the face is facing, is illuminated.

5. The head-mounted front illumination device according to claim 1, characterized in that: a plurality of the illumination parts or a plurality of light sources of the illumination part are provided; the ON/OFF state or the luminosity of each of the light sources is controlled, whereby the illumination range of the illumination part is provided so as to be variable; and the automatic-illumination-range-change-enabling mechanism is configured from an automatic lighting control mechanism in which when the head is tilted downwards and the face is turned downwards causing the main body part worn on the head to tilt downwards and the illumination part also to tilt downwards, a light source on the lower side of the light sources of the illumination part is activated or the luminosity thereof is increased, the illumination range of the downwardly tilted illumination part is expanded or modified downwards, and an area near the hands or an area near the feet, which is even nearer the user than the downward and forward direction in which the face is facing, is illuminated.

6. The head-mounted front illumination device according to claim 1, characterized in that the light scattering state or the reflective light guiding state of the illumination part is provided so as to be variable; the illumination range of the illumination part is provided so as to be variable; and the automatic-illumination-range-change-enabling mechanism is configured from an automatic-illumination-state-change-enabling mechanism in which when the head is tilted downwards and the face is turned downwards causing the main body part worn on the head to tilt downwards and the illumination part also to tilt downwards, the light scattering state or the reflective light guide state of the illumination part is varied and the illumination range is further expanded or modified downwards, and an area near the hands or an area near the feet, which is even nearer the user than the downward and forward direction in which the face is facing, is illuminated.

7. The head-mounted front illumination device according to claim 4, characterized in that the automatic overtilting mechanism comprises a tilt prevention/allowance switching mechanism for: preventing the illumination part, which is provided so as to be capable of tilting vertically, from tilting downwards, and directing the illumination forward, before the main body part tilts downwards; and allowing the illumination part to tilt downwards when the main body part tilts downwards and the illumination part also tilts; and a suspension tilt mechanism in which the main body part tilting downwards causes the tilt prevention/allowance switching mechanism to switch to a tilt allowance state and causes the illumination part to automatically tilt, under gravity, downwards by a predetermined amount or otherwise in correspondence with the incline of the main body part.
